(19) United States
(12) Patent Application Publication
(10) Pub. No.: US 2014/0132894 A1
(43) Pub. Date: May 15, 2014

(54) Flexible Display Device

(71) Applicant: LG Display Co., Ltd, Seoul (KR)

(72) Inventors: SeungMin Lee, Gyeonggi-do (KR); SungJin Park, Gyeongsangbuk-do (KR); JunHo Yeo, Gyeonggi-do (KR)

(73) Assignee: LG Display Co., Ltd, Seoul (KR)

(21) Appl. No.: 14/023,683

(22) Filed: Sep. 11, 2013

(30) Foreign Application Priority Data
Nov. 13, 2012 (KR) 10-2012-0128358

(51) Int. Cl. G02F 1/1333; G02F 1/1335; F21V 9/14; G02B 5/30

(52) U.S. Cl. CPC G02F 1/133305; G02B 5/3025; G02F 1/133528; F21V 9/14
USPC 349/96; 359/492.01; 362/19

(57) ABSTRACT

Disclosed is a flexible display device capable of preventing a bending phenomenon occurring in a high-temperature and high-humidity state, by preventing water from being introduced thereinto, by forming a barrier layer formed of acryl instead of the conventional tri-acetyl cellulose (TAC) film, on the surface of a polarizing device, the barrier layer having a low coefficient of humidity expansion and a low coefficient of thermal expansion. The flexible display device comprises: a display panel configured to output an image; and a polarizing plate attached to an upper surface of the display panel, wherein the polarizing plate comprises: a polarizing device; and a barrier layer formed of an acryl-based resin, and formed on one surface of the polarizing device.

### CROSS-REFERENCE TO RELATED APPLICATION

This application claims priority under 35 U.S.C. §119(a), to Korean Application No. 10-2012-0128358, filed on Nov. 13, 2012, the contents of which is incorporated by reference herein in its entirety.

### BACKGROUND OF THE DISCLOSURE

1. Field of the Invention

The present disclosure relates to a flexible display device, and particularly, to a flexible display device provided with a polarizing plate having a waterproofing function.

2. Background of the Invention

In the recent information-oriented society, the importance of a display device serving as a visual information transmission medium, is being much emphasized. In order to serve as a representative display device, the display device should have low power consumption, a small thickness, a light weight, a high picture quality, etc.

The display device may be categorized into a spontaneous light-emitting type such as a cathode ray tube (CRT), an electro luminescence (EL), a light emitting diode (LED), a vacuum fluorescent display (VFD), an organic light emitting device (OLED), a field emission display (FED) and a plasma display panel (PDP), and a non-spontaneous light-emitting type such as a liquid crystal display (LCD).

A flexible display device, which is not damaged even when being folded or scrolled, is being spotlighted as a new technology in the field of display devices. At present, there are many obstacles in implementing a flexible display device. However, it is expected that a thin film transistor-liquid crystal display device or an organic light emitting device will be mainly presented owing to development of technologies.

Hereinafter, a flexible display device will be explained in more detail.

The flexible display device is called ‘rollable display device’. The flexible display device is implemented on a thin substrate such as a plastic substrate, and is not damaged even when folded or rolled-up like paper. As the flexible display device which is one of the next generation display devices, a liquid crystal display device and an organic light emitting device which can be fabricated to have a thickness of 1 mm or less than, are being spotlighted.

A liquid crystal display (LCD) device, which is an apparatus for displaying an image using anisotropy of liquid crystals, has a more excellent viewing characteristic, smaller power consumption on the same-sized screen and a smaller heat generation amount, than the conventional cathode ray tube. Accordingly, the LCD device is being spotlighted as the next generation display device.

An organic light emitting device (OLED) has an excellent viewing characteristic even at a dark place or even when light is incident thereon from outside, because it emits light spontaneously. Further, the OLED can implement perfect moving images, because its response speed, a criteria for determining performance of a mobile display device, is the most fastest among the existing display devices. Besides, the OLED can make various types of mobile devices such as a mobile phone, have a small thickness due to its ultra-thin design.

In order to implement such flexible display device, a substrate should be flexible. For such flexible substrate, used is a substrate formed of plastic or stainless steel (SUS), rather than the existing glass substrate.

In the LCD device, linear polarizing plates, which are perpendicular to each other, are attached to the upper surface and the lower surface of a liquid crystal (LC) panel, for driving of LC molecules. On the other hand, in the OLED, a circular polarizing plate is attached to an upper surface of an LC panel, for prevention of light reflection.

A flexible display device is bent in a high-temperature and high-humidity state, because it is formed of many layers. Such bending phenomenon due to moisture results from characteristics of polyvinyl alcohol (PVA) used in a polarizing plate.

For instance, in a case where a flexible organic light emitting device is maintained at a reliability environment (85, 85%) for 24 hours, a bending phenomenon may occur.

The PVA is vulnerable to moisture with its moisture absorption ratio of 30% or more than. Further, tri-acetyl cellulose (TAC) film for fixing the PVA, also has a moisture absorption ratio higher than that of a general film, 10 times or more than. That is, the polarizing plate may have its polarizing performance such as a polarization degree and a color, degraded at a high-temperature and high-humidity state, because a moist heat resistance of the TAC is not sufficient.

Especially, in case of a general display device where a polarizing plate is attached onto a glass, a bending phenomenon does not occur even in a high-temperature and high-humidity state, because the glass prevents a bending phenomenon from occurring on the polarizing plate. However, in case of a flexible display device using a flexible substrate, there is no fixing means to compensate for a bending phenomenon of a polarizing plate resulting from moisture. This may cause the flexible display device to be vulnerable to moisture.

Once the polarizing plate has a bending phenomenon, layers disposed below the flexible display device may be destroyed, or the entire part of the flexible display device has a bending phenomenon. This may result in deterioration of the flexible display device.

### SUMMARY OF THE INVENTION

Therefore, an aspect of the detailed description is to provide a flexible display device capable of preventing a bending phenomenon occurring in a high-temperature and high-humidity state.

Another aspect of the detailed description is to provide a flexible display device capable of preventing a bending phenomenon, and capable of reducing a thickness of a polarizing plate.

To achieve these and other advantages and in accordance with the purpose of this specification, as embodied and broadly described herein, there is provided a flexible display device, comprising: a display panel configured to output an image; and a polarizing plate attached to an upper surface of the display panel, wherein the polarizing plate is composed of a polarizing device; and a barrier layer formed of an acryl-based resin, and formed on one surface of the polarizing device.

The display panel may be configured as one of a liquid crystal display device and an organic light emitting device.

The flexible display device may further comprise a protection film attached to an upper surface of the polarizing plate.

The polarizing plate may be attached to an upper surface of the display panel, using an adhesive.

The flexible display device may further comprise a supporting body formed on the other surface of the polarizing device.

The supporting body may be formed of a tri-acetyl cellulose (TAC) film.

The barrier layer may be composed of a first barrier layer and a second barrier layer formed at an upper surface and a lower surface of the polarizing device, respectively.

The barrier layer may be formed to have a thickness of 10˜20 μm.

The acryl-based resin may have a coefficient of humidity expansion of 7˜9×10⁻⁶/% RH, which is lower than that of a polarizing device of 30×10⁻⁶/% RH or more than, and lower than that of a TAC film of 30˜40×10⁻⁶/% RH.

The flexible display device can have the following advantages.

As aforementioned, the acryl-barrier layer having a low coefficient of humidity expansion and a low coefficient of thermal expansion, not the conventional tri-acetyl cellulose (TAC) film, may be formed on the surface of the polarizing device. Under such configuration, introduction of moisture into the polarizing plate can be prevented, and thus a bending phenomenon of the flexible display device occurring in a high-temperature and high-humidity state can be prevented. As a result, reliability of the flexible display device can be enhanced.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the invention.

In the drawings:

FIG. 1 is a sectional view illustrating a structure of a flexible display device according to a first embodiment of the present invention.

FIG. 2 is a sectional view illustrating a display panel of FIG. 1 as an example.

FIG. 3 is a flowchart sequentially illustrating a method for fabricating a flexible display device according to a first embodiment of the present invention.

FIGS. 4A to 4D are sectional views sequentially illustrating a method for fabricating a flexible display device according to a first embodiment of the present invention.

FIG. 5 is a sectional view illustrating a structure of a flexible display device according to a second embodiment of the present invention.

FIG. 6 is a sectional view illustrating a structure of a flexible display device according to a third embodiment of the present invention.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

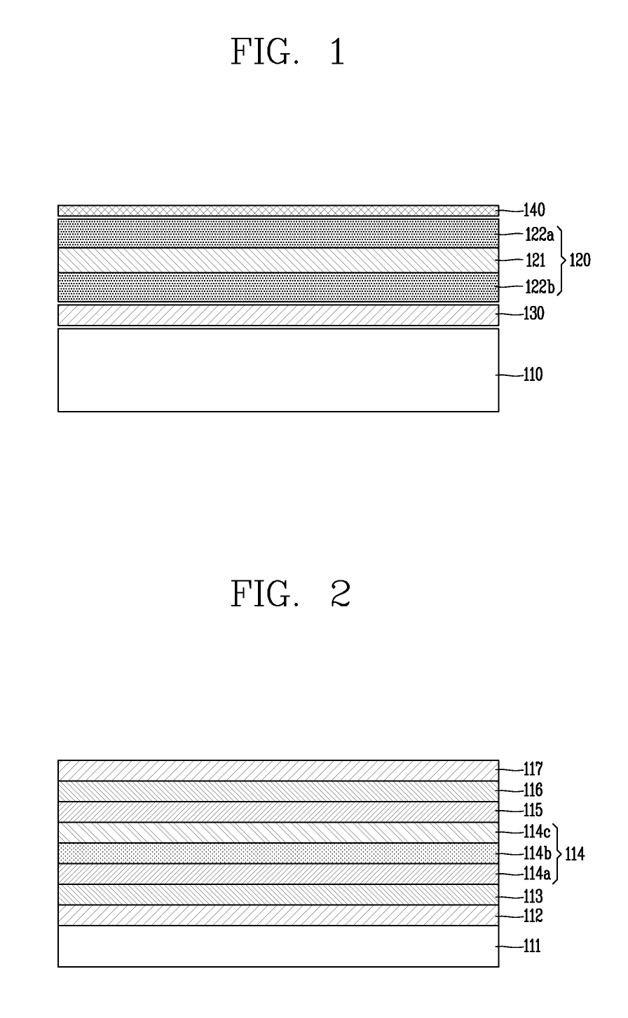

FIG. 1 is a sectional view illustrating a structure of a flexible display device according to a first embodiment of the present invention, and FIG. 2 is a sectional view illustrating a display panel of FIG. 1 as an example. In FIG. 2, the display panel is configured as an organic light emitting device (OLED).

Referring to FIG. 1, a flexible display device according to a first embodiment of the present invention comprises a display panel 110 for outputting an image. A polarizing plate 120 is attached onto the upper surface of the display panel 110 using an adhesive 130.

The upper surface and the lower surface of the display panel 110 do not indicate specific positions. Accordingly, the polarizing plate 120 may be attached onto the lower surface of the display panel 110 using the adhesive 130.

A hard-coating protection film 140 is additionally attached to the upper surface of the polarizing plate 120.

The display panel 110 may be configured as a liquid crystal display (LCD) device, or an organic light emitting device (OLED).

Referring to FIG. 2, in a case where the display panel 110 is configured as an OLED, an anode 112 formed of a transparent oxide is disposed on a substrate 111 formed of plastic or stainless steel. A hole transport layer 113, an emission layer 114, an electron transport layer 115, an electron injection layer 116, and a cathode 117 are disposed on the anode 112, sequentially.

In the OLED having the above structure, a hole injected from the anode 112 and an electron injected from the cathode 117 are coupled to each other at the emission layer 114, via the hole transport layer 113 and the electron transport layer 115, respectively. Then, the hole and the electron move toward a low energy level, thereby generating light of a wavelength corresponding to an energy difference at the emission layer 114.

For emission of white light, the emission layer 114 may be composed of a red emission layer 114a, a green emission layer 114b and a blue emission layer 114c.

The polarizing plate 120 is attached to the upper surface of the display panel 110, using the adhesive 130. The polarizing plate 120 is configured as a circular polarizing plate for prevention of light reflection.

In a case where the display panel 110 is configured as an LCD device, an upper polarizing plate 120 having a light absorption axis in a horizontal direction, is disposed on the upper surface of the display panel 110. Although not shown, a backlight unit is disposed below the display panel 110, and a lower polarizing plate is disposed between the display panel 110 and the backlight unit.

In a case where the display panel 110 is configured as an LCD device, the display panel 110 may be composed of two substrates and a liquid crystal (LC) layer formed between the two substrates.

A thin film transistor (TFT) array is formed at the lower substrate. The TFT array comprises a plurality of data lines to which R, G and B data voltages are supplied; a plurality of gate lines crossing the data lines, and to which a gate pulse is supplied; a plurality of thin film transistors (TFTs) formed at intersections between the data lines and the gate lines; a plurality of pixel electrodes configured to charge liquid crystal (LC) cells with a data voltage; a storage capacitor connected to the pixel electrode, and configured to maintain the data voltage of the LC cells; and so on. A color filter array is formed at the upper substrate. The color filter array comprises a black matrix, a color filter, etc.

In the flexible display device according to a first embodiment of the present invention, the polarizing plate 120 comprises a polarizing device 121, and a first barrier layer 122a and a second barrier layer 122b disposed on the upper surface and the lower surface of the polarizing device 121.

The polarizing device 121 indicates a film which can convert natural light or polarized light into any polarization. As the polarizing device 121, may be used a device having a function to pass one orthogonal component with respect to incident light, or a function to absorb, reflect and scatter another orthogonal component with respect to incident light.

As an optical film applied to the polarizing device 121, any optical films may be used. For instance, the optical film may comprise a high-molecular oriented film mainly formed of a polyvinyl alcohol-based resin containing iodine or a dichroic dye; an O-type polarizing device where a liquid crystal composition containing a dichroic material and a liquid crystal compound is oriented in a prescribed direction; an E-type polarizing device where lyotropic liquid crystals are oriented in a prescribed direction; etc.

The first barrier layer 122a and the second barrier layer 122b may be formed of acryl having no retardation. The acryl has a lower coefficient of humidity expansion (CHE) and a lower coefficient of thermal expansion (CTE), than the conventional tri-acetyl cellulose (TAC) film. However, the present invention is not limited to this. That is, one of the first barrier layer 122a and the second barrier layer 122b may be formed of the conventional TAC film, whereas the other may be formed of acryl.

The polarizing device 121 has a moisture absorption rate higher than that of a general film about 100 times, and the TAC film has a moisture absorption rate higher than that of a general film about 10 times. However, in the conventional art, there was no means to prevent moisture from being introduced into the polarizing device 121. That is, since the conventional polarizing plate using a TAC film is vulnerable to temperature and humidity, it is severely bent when exposed to humidity, or when temperature rising occurs. Such bending phenomenon may cause layers formed below the polarizing plate to be destroyed due to disconnection or brokenness.

On the other hand, the first barrier layer 122a and the second barrier layer 122b formed of acryl having a lower coefficient of humidity expansion and a lower coefficient of thermal expansion, prevent moisture from being introduced into the polarizing device 121 vulnerable to moisture. Under such configuration, the flexible display device is prevented from being bent, and thus has an enhanced reliability. The coefficient of humidity expansion of the acryl is 7˜9×10⁻⁶/% RH, which is lower than 30×10⁻⁶/% RH or more than of the polarizing device 121, and lower than 30˜40×10⁻⁶/% RH of the TAC film.

Further, the barrier layers formed of acryl can perform a main function of the conventional TAC film, i.e., protecting the polarizing device 121.

According to the first embodiment, the first barrier layer 122a and the second barrier layer 122b are formed on the upper surface and the lower surface of the polarizing device 121, thereby preventing moisture from being introduced into the polarizing device 121. Accordingly, the polarizing plate can be prevented from being bent in a high-temperature and high-humidity state.

For example, in a high temperature and high humidity state, more specifically after being kept at a reliability environment (85° C., 85%) for 24 hours not the conventional TAC film, but barrier layers formed of acryl are disposed on the upper surface and the lower surface of the polarizing device. In this case, the flexible OLED was partially bent by high temperature, but was scarcely bent by humidity.

Further, the barrier layers formed of acryl have a thickness of 10˜20 μm, respectively, whereas the conventional TAC film has a thickness of 40 μm. Under such configuration, the flexible display device can have a reduced thickness, and an enhanced transmittance.

Hereinafter, a method for fabricating a flexible display device according to a first embodiment of the present invention will be explained in more detail with reference to the attached drawings.

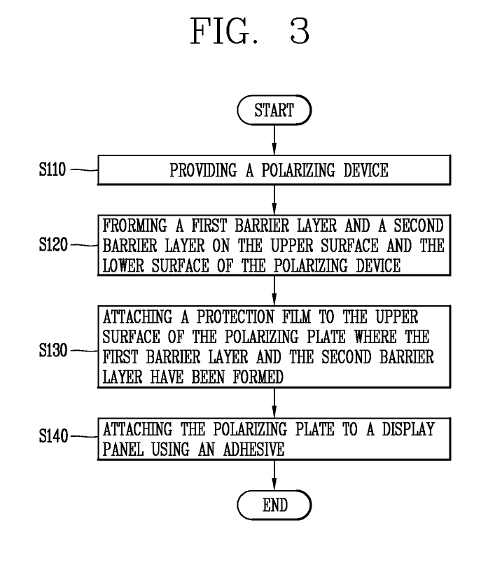

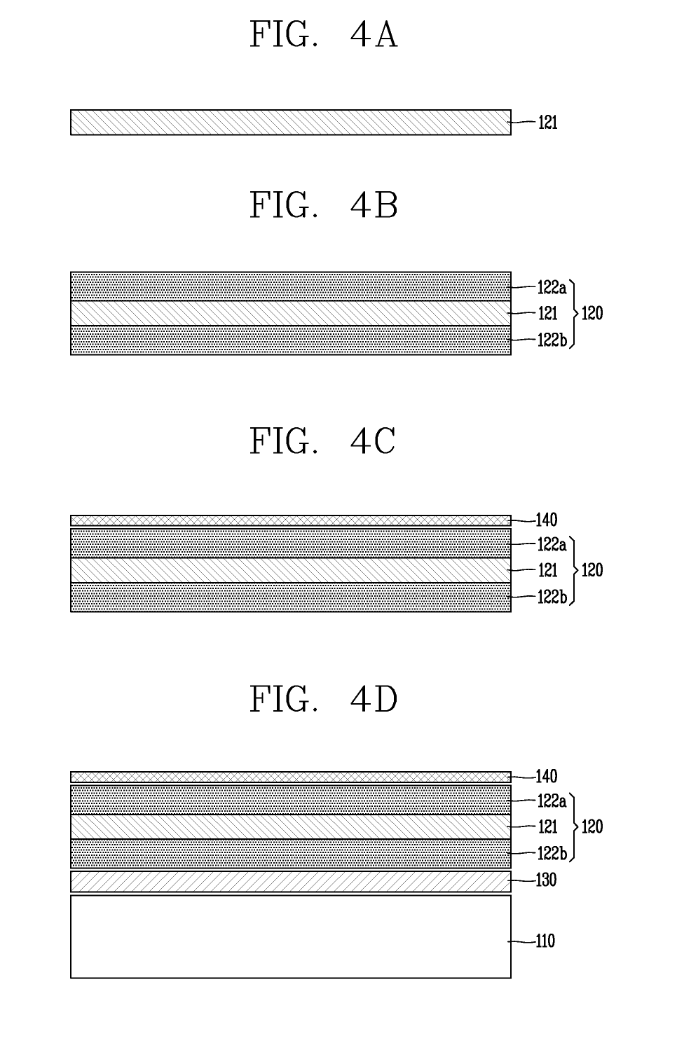

FIG. 3 is a flowchart sequentially illustrating a method for fabricating a flexible display device according to a first embodiment of the present invention, and FIGS. 64A to 4D are sectional views sequentially illustrating a method for fabricating a flexible display device according to a first embodiment of the present invention.

As shown in FIG. 4A, a prescribed film is oriented to provide a polarizing device 121 (S110).

For instance, the polarizing device 121 may be formed as a dichroic material is absorbed to a polyvinyl alcohol (PVA)-based film.

The PVA-based resin of the polarizing device 121 may be obtained as polyvinyl acetate-based resin is made into a soap. As the polyvinyl acetate-based resin, may be used polyvinyl acetate, a homopolymer of vinyl acetate, or a copolymer of vinyl acetate and other monomer, etc.

Such polarizing device 121 may be fabricated as the PVA-based film is dyed using a dichroic material, and undergoes cross-linking, uniaxial orientation, and washing/drying processes using a boric acid solution.

Then, as shown in FIG. 4B, a first barrier layer 122a and a second barrier layer 122b are formed on the upper surface and the lower surface of the polarizing device 121, thereby fabricating a polarizing plate 120 (S120).

The first barrier layer 122a and the second barrier layer 122b prevent moisture from being introduced into the polarizing device 121 vulnerable to moisture. Under such configuration, the flexible display device is prevented from being bent, and thus has an enhanced reliability.

For this, the first barrier layer 122a and the second barrier layer 122b may be formed of acryl having no retardation. The acryl has a lower coefficient of humidity expansion (CHE) and a lower coefficient of thermal expansion (CTE), than the conventional tri-acetyl cellulose (TAC) film.

The first barrier layer 122a and the second barrier layer 122b formed of acryl may have a thickness of 10˜20 μm, respectively.

As shown in FIG. 4C, a hard-coating protection film 140 may be additionally attached to the upper surface of the polarizing plate 120 where the first barrier layer 122a and the second barrier layer 122b have been formed (S130).

As shown in FIG. 4D, the polarizing plate 120 is attached to a display panel 110 using an adhesive 130 (S140).

As the adhesive 130, may be used any materials capable of attaching the display panel 110 and the polarizing plate 120 to each other, having excellent optical transparency, and having no change in adhesion as time lapses. For instance, the adhesive 130 may be formed of an adhesive composition containing a PVA-based resin and a cross-linking agent.

The display panel 110 may be configured as one of an LCD device and an OLED.

As aforementioned, in a case where the display panel 110 is configured as an OLED, an anode formed of a transparent oxide is disposed on a substrate formed of plastic or stainless steel. A hole transport layer, an emission layer, an electron transport layer, an electron injection layer, and a cathode may be disposed on the anode, sequentially.

In a case where the substrate is formed of polyimide (PI), a back film formed of plastic such as polyethylene terephthalate (PET) or metal such as stainless steel, may be attached to the rear surface of the substrate.

In the flexible display device according to the present invention, one of the first barrier layer and the second barrier layer may be formed of the conventional TAC film, while the other may be formed of acryl. This will be explained in more detail in a second embodiment and a third embodiment of the present invention.

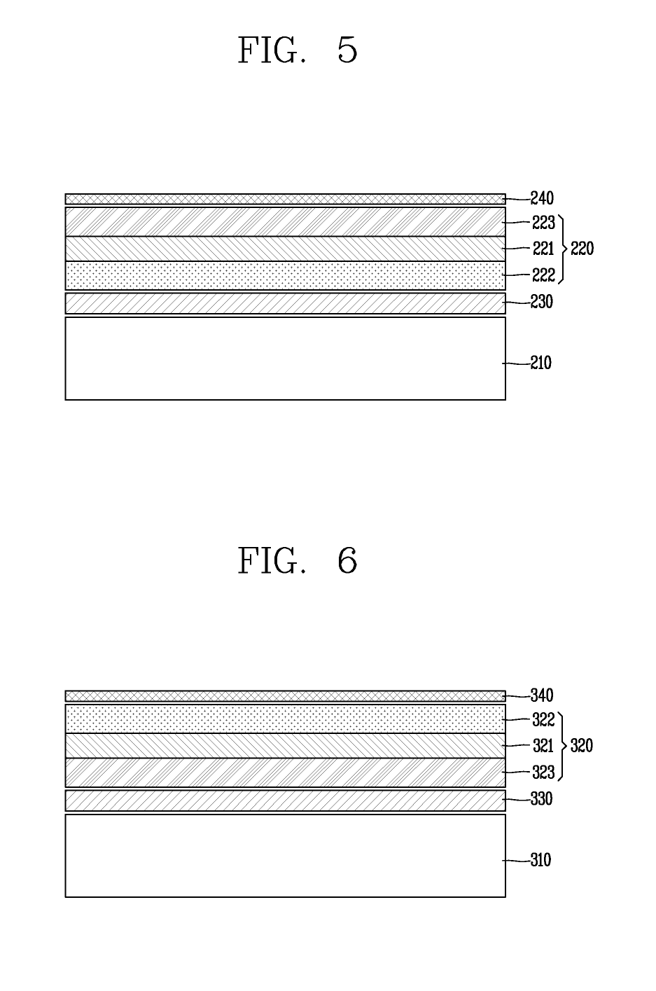

FIG. 5 is a sectional view illustrating a structure of a flexible display device according to a second embodiment of the present invention.

The flexible display device according to the second embodiment is the same as the flexible display device according to the first embodiment, except that a TAC film rather than an acryl layer is formed on the upper surface of the polarizing device.

As shown, the flexible display device according to the second embodiment comprises a display panel 210 configured to output an image. A polarizing plate 220 is attached to the upper surface of the display panel 210 using an adhesive 230.

A hard-coating protection film 240 may be additionally attached to the upper surface of the polarizing plate 220.

As aforementioned, the display panel 210 may be configured as one of an LCD device and an OLED.

Although not shown, in a case where the display panel 210 is configured as an OLED, an anode formed of a transparent oxide is disposed on a substrate formed of plastic or stainless steel. A hole transport layer, an emission layer, an electron transport layer, an electron injection layer, and a cathode are disposed on the anode, sequentially.

The polarizing plate 220 is attached to the upper surface of the display panel 210 using the adhesive 230. The polarizing plate 220 is configured as a circular polarizing plate for prevention of light reflection.

On the other hand, in a case where the display panel 210 is configured as an LCD device, an upper polarizing plate 220 having a light absorption axis in a horizontal direction, is disposed on the upper surface of the display panel 210. Although not shown, a backlight unit is disposed below the display panel 210, and a lower polarizing plate is disposed between the display panel 210 and the backlight unit.

In a case where the display panel 210 is configured as an LCD device, the display panel 210 may be composed of two substrates and a liquid crystal (LC) layer formed between the two substrates.

In the flexible display device according to the second embodiment of the present invention, the polarizing plate 220 comprises a polarizing device 221, a supporting body disposed on the upper surface of the polarizing device 221, and a barrier layer 222 disposed on the lower surface of the polarizing device 221.

The supporting body 223 may be formed of a general protection film having no retardation. For instance, the supporting body 223 may be formed of a TAC film.

As an optical film applied to the polarizing device 221, any optical films may be used. For instance, the optical film may comprise a high-molecular oriented film mainly formed of a polyvinyl alcohol-based resin containing iodine or a dichroic dye; an O-type polarizing device where a liquid crystal composition containing a dichroic material and a liquid crystal compound is oriented in a prescribed direction; an E-type polarizing device where lyotropic liquid crystals are oriented in a prescribed direction; etc.

The barrier layer 222 may be formed of acryl having no retardation. The barrier layer 222 formed of acryl has a lower coefficient of humidity expansion (CHE) and a lower coefficient of thermal expansion (CTE), than the conventional TAC film.

FIG. 6 is a sectional view illustrating a structure of a flexible display device according to a third embodiment of the present invention.

The flexible display device according to the third embodiment is the same as the flexible display device according to the first embodiment, except that a TAC film rather than an acryl layer is formed on the lower surface of the polarizing device.

As shown, the flexible display device according to the third embodiment comprises a display panel 310 configured to output an image. A polarizing plate 320 is attached to the upper surface of the display panel 310 using an adhesive 330.

A hard-coating protection film 340 of may be additionally attached to the upper surface of the polarizing plate 320.

As aforementioned, the display panel 310 may be configured as one of an LCD device and an OLED.

Although not shown, in a case where the display panel 310 is configured as an OLED, an anode formed of a transparent oxide is disposed on a substrate formed of plastic or stainless steel. A hole transport layer, an emission layer, an electron transport layer, an electron injection layer, and a cathode are disposed on the anode, sequentially.

The polarizing plate 320 is attached to the upper surface of the display panel 310 using the adhesive 330. The polarizing plate 320 is configured as a circular polarizing plate for prevention of light reflection.

On the other hand, in a case where the display panel 310 is configured as an LCD device, an upper polarizing plate 320 having a light absorption axis in a horizontal direction, is disposed on the upper surface of the display panel 310. Although not shown, a backlight unit is disposed below the display panel 310, and a lower polarizing plate is disposed between the display panel 310 and the backlight unit.

In a case where the display panel 210 is configured as an LCD device, the display panel 210 may be composed of two substrates and a liquid crystal (LC) layer formed between the two substrates.

In the flexible display device according to the second embodiment of the present invention, the polarizing plate 220 comprises a polarizing device 221, a supporting body disposed on the upper surface of the polarizing device 221, and a barrier layer 222 disposed on the lower surface of the polarizing device 221.

The supporting body 223 may be formed of a general protection film having no retardation. For instance, the supporting body 223 may be formed of a TAC film.

As an optical film applied to the polarizing device 221, any optical films may be used. For instance, the optical film may comprise a high-molecular oriented film mainly formed of a polyvinyl alcohol-based resin containing iodine or a dichroic dye; an O-type polarizing device where a liquid crystal composition containing a dichroic material and a liquid crystal compound is oriented in a prescribed direction; an E-type polarizing device where lyotropic liquid crystals are oriented in a prescribed direction; etc.

The barrier layer 322 may be formed of acryl having no retardation. The barrier layer 322 formed of acryl has a lower coefficient of humidity expansion (CHE) and a lower coefficient of thermal expansion (CTE), than the conventional TAC film.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A flexible display device, comprising:
a display panel configured to output an image; and
a polarizing plate attached to an upper surface of the display panel,
wherein the polarizing plate comprises:
a polarizing device; and
a barrier layer formed of an acryl-based resin, and formed on one surface of the polarizing device.

2. The flexible display device of claim 1, wherein the display panel is configured as one of a liquid crystal display device and an organic light emitting device.

3. The flexible display device of claim 2, further comprising a protection film attached to an upper surface of the polarizing plate.

4. The flexible display device of claim 3, wherein the polarizing plate is attached to an upper surface of the display panel, using an adhesive.

5. The flexible display device of claim 1, further comprising a supporting body formed on the other surface of the polarizing device.

6. The flexible display device of claim 5, wherein the supporting body is formed of a tri-acetyl cellulose (TAC) film.

7. The flexible display device of claim 1, wherein the barrier layer comprises a first barrier layer and a second barrier layer formed at an upper surface and a lower surface of the polarizing device, respectively.

8. The flexible display device of claim 7, wherein the barrier layer is formed to have a thickness of 10˜20 μm.

9. The flexible display device of claim 1, wherein the acryl-based resin has a coefficient of humidity expansion of 7˜9×10⁻⁶/% RH, which is lower than that of a polarizing device of 30×10⁻⁶/% RH or more than, and lower than that of a TAC film of 30˜40×10⁻⁶/% RH.
